(19) United States
(12) Patent Application Publication
(10) Pub. No.: US 2005/0078553 A1
(43) Pub. Date: Apr. 14, 2005

(54) Static mixer

(75) Inventor: Karsten Wilken, Kagerod (SE)

Correspondence Address: BURNS DOANE SWECKER & MATHIS L L P, POST OFFICE BOX 1404, ALEXANDRIA, VA, 22313-1404, US

(73) Assignee: TETRA LAVAL HOLDINGS & FINANCE SA, Pully (CH)

(21) Appl. No.: 10/499,207

(22) PCT Filed: Dec. 19, 2002
(86) PCT No.: PCT/SE02/02403

(30) Foreign Application Priority Data
Dec. 21, 2001 (SE) 0104362-9

(51) Int. Cl. B01F 5/06

(52) U.S. Cl. 366/336; 138/44

(57) ABSTRACT

The invention relates to a static mixer for continuous mixing of one or more input streams or flows. The mixer comprising a pipe section (2) of a certain length, the pipe length being pinched together so that a number of radial throttles (4) is formed. The throttles (4) are uniformly distributed along the pipe section (2). Two adjacent throttles (4) are moreover oriented at 90° in relation to one another.

### TECHNICAL FIELD

The present invention relates to a static mixer for the continuous mixing of one or more flows or input streams, comprising a pipe section of a given length.

### BACKGROUND ART

Static (or motionless) mixers occur in a multiplicity on the market and they are employed for mixing one or more input streams or flows. The geometric construction of such a mixer may vary, but a feature common to all static mixers is that they have mixing elements which are not moveable.

One or more input streams or flows are pumped into the mixer and, via the stationary mixing elements, the different streams in the flow are deviated a number of times so that the mixing becomes homogeneous. The number of mixing elements depends on how resistant to mixing the different input streams are.

Static mixers are often employed in the food industry when the intention is to mix together two different input streams or when the intention is to ensure that one and the same stream has a homogeneous temperature distribution after heat treatment. The food product may contain fibres or particles and, since many of the prior art mixers often have mixing elements which display sharp edges, these mixers are not suitable for such products. Fibres or particles may adhere to the sharp edges and cleaning of the mixer is also impeded by the design of the mixer elements.

A static mixer is described in European Patent Specification EP 604116. This mixer has mixing elements which are wing-shaped and are gently rounded towards the flow direction. Particles and fibres in a product readily pass the mixing elements which are designed in such a manner, and the mixer is moreover easy to clean given the severe demands on hygiene which are in place within the food industry. However, a static mixer according to the foregoing is relatively expensive to manufacture and, in addition, is adapted for relatively large flows.

### OBJECTS OF THE INVENTION

One object of the present invention is to realise a static mixer which is designed so that products containing fibres and particles do not adhere when the product passes through the mixer. The mixer should also be easily cleaned, given the severe demands on hygiene which are in place within the food industry.

A further object of the present invention is that the static mixer be simple and economical to manufacture. It must also be capable of being used for relatively small flows.

Solution

These and other objects have been attained according to the present invention in that the mixer of the type described by way of introduction has been given the characterising feature that the pipe section is pinched so that a number of radial throttles are disposed along the pipe section, and that these throttles are uniformly distributed along the pipe section, and that two adjacent throttles are oriented at 90° in relation to each other.

Preferred embodiments of the present invention have further been given the characterising features as set forth in the appended subclaims.

### BRIEF DESCRIPTION OF THE ACCOMPANYING DRAWINGS

One preferred embodiment of the present invention will now be described in greater detail hereinbelow, with reference to the accompanying Drawings. In the accompanying Drawings:

FIG. 1 shows, partly in section, a side elevation of a static mixer according to the present invention;

FIG. 2 is a cross section taken along the line A-A through the static mixer;

FIG. 3 is a cross section taken along the line B-B through the static mixer; and

FIG. 4 is a cross section taken along the line C-C through the static mixer.

### DESCRIPTION OF PREFERRED EMBODIMENT

The present invention consists of a static mixer 1 as shown in FIG. 2. The mixer 1 may be employed for mixing two input streams or flows which are brought together immediately ahead of the mixer 1, or alternatively a distance before the flows arrive at the mixer 1. However, in the preferred embodiment, the mixer 1 is intended to be placed immediately after heat treatment equipment, such as an injector.

In an injector, which gives a direct heating method, pressurised steam is sprayed through a nozzle directly into the product which is to be heat treated. Since many injector nozzles are annular, a somewhat uneven distribution may be obtained of heat in the product, so that different heat zones may occur concentrically in the product pipe.

In order to be certain that the heating reaches all parts of the product flow and in order to avoid over-treatment, it is desirable to ensure a uniform heat in the product before this arrives at a buffer pipe. In the buffer pipe, the product is intended to stay at a given temperature for a given time interval in order that the product have achieved adequate heat treatment. By placing a mixer 1 according to the present invention immediately after an injector, there will be obtained an efficient mixing of the product so that all parts of the product flow have the same temperature.

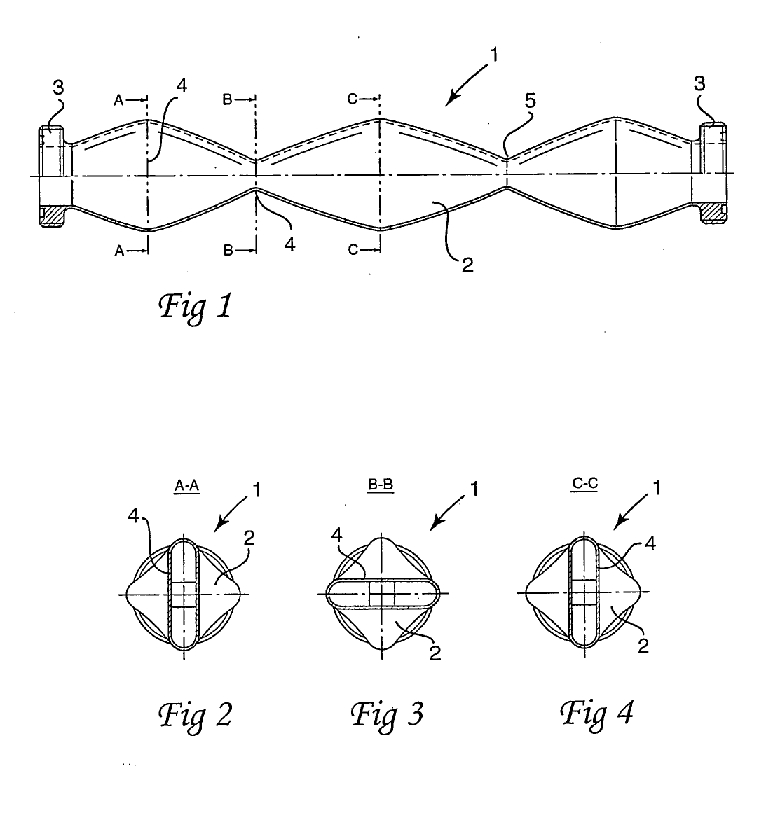

The mixer 1 in FIG. 1 consists of a pipe section 2 of a predetermined length. The length is determined by how resistant to mixture the product is, so that a more sparingly mixed product requires a longer pipe section 2. In both ends, the pipe section 2 has conventional pipe couplings 3 in order that the mixer 1 can be coupled into a conduit. Preferably, the pipe section 2 is of the same dimensions as the surrounding conduit (not shown on the Drawings). The mixer 1 is symmetrical and either end may be employed as inlet or outlet.

The pipe section 2 is pinched together transversely so that radial throttles 4 occur. The throttles 4 are shown in FIG. 2-4. FIG. 2-4 are cross sections through the pipe section 2 and they are placed where the throttles 4 are narrowest. The throttles 4 will have a largely oval appearance. In order not to subject the material in the pipe section 2 to excessive stresses in the manufacture of the mixer 1, the radius 5 in the throttle 4 should be as large as possible.

The number of throttles 4 depends upon the length of the pipe section 2. The throttles 4 are uniformly distributed along the length of the pipe section 2. Every second throttle 4 is offset in such a manner that two adjacent throttles are oriented at 90° in relation to each other. The oval-shaped throttles 4 are alternatingly oriented as shown in FIG. 2 and FIG. 3. That part of the pipe section 2 which constitutes the space between each throttle 4 will thereby have a tetrahedral appearance.

The distance between two throttles 4 is determined by how much the material may be deformed without cracking. Normally, the distance is equal to the diameter of the pipe section 2 multiplied by 1.5-2. The material in the mixer 1 is preferably stainless steel, since this material displays the best properties as regards hygienic food applications.

In the preferred embodiment, the mixer 1 is intended to be employed immediately after an injector. That product which is to be heat treated in the injector is pumped into the injector and steam under high pressure is introduced through a number of inlets. The steam and the product are forced together through annular nozzles and the directly heated product thereafter leaves the injector. As a result of the design of the injector, concentric heating zones may occur in the product pipe which departs from the injector.

By placing the mixer 1 according to the present invention immediately after the injector (not shown on the Drawings), the product flow is forced to pass through a number of throttles 4 where the concentric heating zones are deflected and mixed with one another. By orienting every second throttle 4 through 90° offset, the mixing is effectively increased. Immediately after the mixer 1, the product is led into a buffer pipe (not shown on the Drawings), where the product is intended to stay at a certain temperature during a certain period of time.

The mixer 1 according to the present invention is particularly suitable for products containing fibres or particles, such as juices or the like. There are no sharp edges or pockets which the product must pass and where fibres and particles may adhere. Also in cleaning, so-called CIP (Cleaning In Place) the mixer 1 enjoys major advantages since the interior of the mixer 1 displays exclusively gently rounded surfaces.

A mixer 1 according to the present invention may also be employed for relatively small flows, since the diameter of the pipe section 2 may be varied depending upon the product flow. In principle, a mixer 1 may be manufactured from pipe sections 2 of all dimensions. The manufacturing process is relatively simple and economical compared with other static mixers occurring on the market.

As will have been apparent from the foregoing description, the present invention realises a mixer which, in an efficient manner, mixes one or more flows. The mixer is particularly suitable for products which contain fibres and particles, since the mixer displays no mixing elements with sharp edges. The mixer is simple and economical to manufacture.

1. A static mixer for continuous mixing of one or more input streams or flows, comprising a pipe section of a certain length, wherein the pipe section is pinched together so that a number of radial throttles are disposed along the pipe section and that these throttles are uniformly distributed along the pipe section, and that two adjacent throttles are oriented at 90° in relation to one another.

2. The static mixer as claimed in claim 1, wherein the distance between two adjacent throttles is 1.5-2 times the diameter of the pipe section A.

3. The static mixer as claimed in claim 1, wherein the throttles have a substantially oval appearance and that the pipe section between two throttles has a tetrahedral appearance.

4. The static mixer as claimed in claim 1, wherein the mixer is manufactured from stainless steel.
